(19) United States
(12) Patent Application Publication
(10) Pub. No.: US 2023/0366109 A1
(43) Pub. Date: Nov. 16, 2023

(54) SOLID ACID ELECTROCHEMICAL CELLS FOR THE PRODUCTION OF HYDROGEN

(71) Applicants: Northwestern University, Evanston, IL (US); SAFCELL INC., Pasadena, CA (US)

(72) Inventors: Dae-Kwang Lim, Daejeon (KR); Austin Blake Plymill, Newark, DE (US); Sossina M. Haile, Evanston, IL (US); Calum C.R. I. Chisholm, Pasadena, CA (US); Strahinja Zecevic, Tustin, CA (US)

(21) Appl. No.: 18/027,468

(22) PCT Filed: Oct. 5, 2021
(86) PCT No.: PCT/US21/53466

§ 371 Date: Mar. 21, 2023

Related U.S. Application Data
(60) Provisional application No. 63/088,111, filed on Oct. 6, 2020.

(51) Int. Cl. C25B 9/23; C25B 1/02; C25B 13/05; C25B 11/065; C25B 11/081; C25B 11/054; B01J 23/58; B01J 23/80; B01J 23/42; B01J 21/18; C01B 3/04; C01B 3/32; C01B 3/16; C01B 3/26

(52) U.S. Cl. CPC C25B 9/23; C25B 1/02; C25B 13/05; C25B 11/065; C25B 11/081; C25B 11/054; B01J 23/58; B01J 23/80; B01J 23/42; B01J 21/185; C01B 3/047; C01B 3/326; C01B 3/16; C01B 3/26; C01B 2203/0233; C01B 2203/0283; C01B 2203/0277; C01B 2203/1223; C01B 2203/1252; C01B 2203/1082; C01B 2203/1076; C01B 2203/107; C01B 2203/067

(57) ABSTRACT

Electrochemical cells for the production of hydrogen from liquid fuels and methods of operating the cells to produce hydrogen and electricity are provided. The electrochemical cells are solid state cells that incorporate a thermochemical conversion catalyst and a hydrogen oxidation catalyst into the anode and utilize solid acid electrolytes. This cell design integrates thermally driven chemical conversion of a starting fuel with electrochemical removal of hydrogen from the conversion reaction zone.

### CROSS-REFERENCE TO RELATED APPLICATIONS

The present application claims priority to U.S. provisional patent application No. 63/088,111 that was filed Oct. 6, 2020, the entire contents of which are incorporated herein by reference.

### REFERENCE TO GOVERNMENT RIGHTS

This invention was made with government support under C2017.0013//DE-AR0000813 awarded by the Department of Energy. The government has certain rights in the invention.

### BACKGROUND

Hydrogen has been proposed as an energy carrier in a sustainable energy future. When coupled with fuel cells, the energy content is converted on demand and with high efficiency into useful work, with water being the only emission generated at the point of use. However, hydrogen has a low volumetric energy density, a low flash-point, and lacks a wide infrastructure for its storage and transport. These challenges have caused a reconsideration of early commitments of national governments to hydrogen fuel cells. (Bullis, K. (2009). Q & A: Energy Secretary Steven Chu. In MIT Technology Review.) Thus, realization of the potential environmental benefits of fuel cell technology is likely to rely on the identification of viable solutions to hydrogen storage and delivery. Ammonia has recently been suggested as an ideal candidate to act as a hydrogen vessel. (Soloveichik, G. (2016). UCLA Luskin Conference Center, Los Angeles, CA: NH₃ Fuel Association; Klerke, A. et al., (2008) Journal of Materials Chemistry 18, 2304-2310; Rouwenhorst, K. H. R. et al., (2019) Renewable & Sustainable Energy Reviews 114; and Lamb, K. E. et al., International Journal of Hydrogen Energy 44, 3580-3593.) Ammonia is lightweight, less flammable than hydrogen, easily liquefiable, commercially produced at high volume, and can make use of an existing transportation infrastructure. Furthermore, although most ammonia production today utilizes hydrogen derived from natural gas and hence contributes to green-house gas emissions, cycling between stored hydrogen in ammonia and retrieved hydrogen can, in principle, be done without producing additional emissions.

The retrieval of hydrogen stored in ammonia is described by the decomposition reaction:

$${NH}_{3} \to \frac{1}{2} {N}_{2} + \frac{3}{2} {H}_{2} . \qquad ( 1 )$$

This reaction is mildly endothermic at standard conditions, and under standard pressure it proceeds spontaneously at temperatures greater than 183° C. Achieving high conversion, however, requires high temperatures, typically above about 400° C., to overcome the twin challenges of thermodynamic limitations and kinetic barriers. Residual ammonia in the fuel stream resulting from incomplete conversion is, in turn, highly detrimental to polymer electrolyte membrane fuel cells, the catalysts of which can tolerate no more than ˜0.1 ppm NH₃. (Uribe, F. A. et al., (2002). Journal of the Electrochemical Society 149, A293-A296; and Miyaoka, H. et al., (2018). International Journal of Hydrogen Energy 43, 14486-14492.) As an alternative to high temperature thermal decomposition, electrochemical decomposition of ammonia holds potential for production of high purity hydrogen at near ambient conditions and with high conversion rates. To date, electrocatalytic approaches, which have largely employed aqueous alkali electrolytes, have required high operating potentials, implying poor energy efficiency, and have suffered from catalyst deactivation over time. (Modisha, P. et al., (2016). International Journal of Electrochemical Science 11, 6627-6635; and Vitse, F. et al., (2005). Journal of Power Sources 142, 18-26.) Accordingly, innovations in ammonia-to-hydrogen conversion are required if ammonia is to provide hydrogen on demand and serve as a flexible energy delivery medium.

### SUMMARY

Electrochemical cells for the production of hydrogen from fuels and methods of operating the cells to produce hydrogen and electricity are provided. One embodiment of an electrochemical cell includes: a catalyst layer that includes a thermochemical conversion catalyst; an electrooxidation layer that includes a hydrogen oxidation catalyst adjacent to the catalyst layer; a proton conducting membrane that includes a solid acid electrolyte adjacent to the electrooxidation layer; a hydrogen evolution layer that includes a hydrogen evolution catalyst that is separated from the electrooxidation layer by the proton conducting membrane; and a circuit that provides a path for electrons generated in the electrooxidation layer to travel to the hydrogen evolution layer.

### BRIEF DESCRIPTION OF THE DRAWINGS

Illustrative embodiments of the invention will hereafter be described with reference to the accompanying drawings, wherein like numerals denote like elements.

FIG. 1 shows a schematic of the hybrid thermal-electrochemical cell for on-demand ammonia-to-hydrogen conversion. The thermal cracking catalyst layer (TCL) is adjacent to the hydrogen oxidation electrocatalyst layer (EL), which is in turn, adjacent to a membrane of the solid-state proton conductor, cesium dihydrogen phosphate (CDP). On the opposite side of the membrane is a layer that includes the hydrogen evolution electrocatalyst.

FIGS. 2A-2D show electrochemical characteristics of hybrid thermal-electrochemical cells designed for on-demand ammonia-to-hydrogen conversion: FIG. 2A shows polarization curves obtained upon supply of the gases indicated, along with computed H₂ production for 100% Faradaic efficiency; FIG. 2B shows measurement of H₂ evolved from cathode demonstrating 100% Faradaic efficiency; FIG. 2C shows implied NH₃ to H₂ conversion in FIG. 2A upon supply of the gases indicated; and FIG. 2D shows a comparison of polarization curves of a bilayer (TCL+EL) electrode and single component electrodes, as indicated, under supply of 0.4 atm pNH₃. Data of bilayer-electrode cells are the averages from three distinct cells. (T=250° C.; supply to anode: 0.38 atm pH₂O, balance N₂; supply to cathode: 0.62 atm pH₂, balance H₂O.)

FIG. 3 shows a comparison, on a catalyst mass normalized basis, of the hydrogen generation rate obtained from the hybrid thermal-electrochemical approach of the Example (pNH₃=0.6 atm) with thermal decomposition as reported in the literature.

FIG. 4 shows a schematic representation of one embodiment of a solid acid hydrogen generation cell, in which the TCL is replaced with a chemical catalyst layer. The composition of the chemical catalyst layer can be changed depending on type of fuel used as the source of hydrogen. For example, the chemical catalyst layer could be ruthenium on carbon for ammonia decomposition, platinum on ceria mixed with carbon for methylcyclohexane dehydrogenation, or copper and zinc on alumina mixed with carbon for methanol steam reforming.

FIG. 5 shows polarization curves for a 12-cell solid acid hydrogen stack running on the fuel gas streams indicated.

### DETAILED DESCRIPTION

Electrochemical cells for the production of hydrogen from fuels and methods of operating the cells to produce hydrogen and electricity are provided. The electrochemical cells are solid state cells that incorporate a thermochemical conversion catalyst and a hydrogen oxidation catalyst into the anode and utilize solid acid electrolytes. This hybrid thermal-electrochemical cell design integrates thermally driven chemical conversion of the starting fuel with electrochemical removal of the hydrogen from the conversion reaction zone. The cells are able to produce hydrogen that is free from residual fuel, do not require solvents or high operating pressures, and, because the cells are able to convert fuels internally, eliminate the need for an external cracker.

The electrochemical cells can be used to produce hydrogen (H₂) from a variety of hydrogen-containing fuels. Some embodiments of the cells are designed to produce hydrogen from ammonia at relatively low operating temperatures, including temperatures below 300° C. Other fuels that can be used include alcohols, such as methanol and ethanol, formic acid, and dimethyl ether. Further, hydrogen can be produced from hydrogenated hydrocarbons such as methylcyclohexane, perhydro-dibenzyl-toluene, propanol-2, and perhydro-N-ethylcarbazole, which “dehydrogenate” into toluene, dibenzyl-toluene, acetone, and N-ethylcarbazole, respectively.

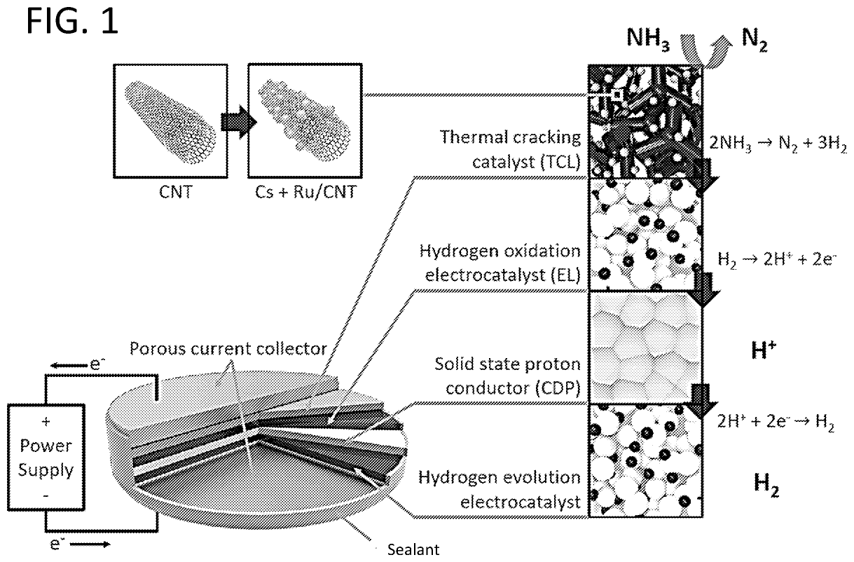

One embodiment of an electrochemical cell is shown in FIG. 1. The cell includes a bilayered anode comprising a catalyst layer adjacent to an electrooxidation layer (EL) that includes a hydrogen oxidation catalyst. The catalyst layer includes a thermochemical conversion catalyst. As used herein, the term “thermochemical conversion catalyst” refers to a catalyst is thermally activated and catalyzes the conversion of a fuel to H₂ and one or more additional products. Such catalysts are sometimes referred to simply as chemical conversion catalysts, and, for the purposes of this disclosure, are distinguishable from electrocatalysts. In some embodiments, the thermochemical conversion catalyst is a thermal cracking catalyst (TCL; also referred to as a thermal decomposition catalyst). The counter electrode is a hydrogen evolution layer that includes a hydrogen evolution catalyst. A solid-state proton conductor separates the electrooxidation layer from the hydrogen evolution layer. In FIG. 1, the solid-state proton conductor is illustrated using the solid acid cesium dihydrogen phosphate (CDP), but other solid-state, proton conducting electrolytes can be used. The electrochemical cell further includes current collectors on either end of the electrochemical cell stack and an external circuit providing electrical communication between the electrooxidation layer and the hydrogen evolution layer.

When a hydrogen atom-containing fuel is fed into a catalyst layer, the thermochemical conversion catalyst catalyzes a reaction that converts the fuel into H₂ and one or more additional products. For example, when a hydrogen atom-containing fuel is fed into a catalyst layer that includes a thermal cracking catalyst, the catalyst catalyzes the decomposition (“cracking”) of the fuel into H₂ and one or more additional decomposition products. If ammonia is used as a fuel, the thermochemical decomposition catalyst decomposes the ammonia into H₂ and N₂. The selection of the thermochemical conversion catalyst will depend upon the fuel being used. Examples of thermochemical conversion catalysts that can be used for the conversion of ammonia and other hydrogen atom-containing fuels include ruthenium (Ru), rhodium (Rh), iridium (Ir), nickel (Ni), platinum (Pt), palladium (Pd), gold (Au), silver (Ag), copper (Cu), zinc (Zn), and iron (Fe), and combinations thereof. Metal nitrides and metal carbides of transition metals, such as Fe, cobalt (Co), Ni, titanium (Ti), vanadium (V), manganese (Mn), and chromium (Cr) can also be used.

Examples of ruthenium-based catalysts for thermochemical decomposition of ammonia are described in Hill et al., International Journal of Hydrogen Energy 39, 7646-7654; Hill et al., Applied Catalysis B-Environmental 172, 129-135; Li et al., Nano Research 11, 4774-4785; Mukherjee et al., Applied Catalysis B-Environmental 226, 162-181; and Yin et al., Applied Catalysis a-General 277, 1-9, the contents of which are incorporated herein by reference for the purpose of providing additional examples of thermochemical decomposition catalysts.

In addition to the thermochemical conversion catalyst, the catalyst layer may include a support for the catalyst and/or a promoter. Examples of supports include carbon nanotubes (CNTs), activated carbon, and particles of metal/metalloid oxides, such as Al₂O₃, SiO₂, TiO₂, and ZrO₂. The promoters are substances that are mixed with the thermochemical decomposition catalyst to improve the efficiency of the catalyst. They may do so by a variety of mechanisms. For example, promoters may prevent crystal sintering. Examples of promoters that can be used with ruthenium and other thermochemical conversion catalysts include alkali, alkaline earth, and rare earth metals, such as cesium (Cs), potassium (K), barium (B), sodium (Na), lithium (Li), cerium (Ce), and lanthanum (La).

The catalyst layer may include an electronically conductive component, such as particles of carbon, such as carbon black, metallic carbon nanotubes (CNTs), and graphite, and particles of metal, to provide, or enhance, electrical conductivity through the catalyst layer, wherein the thermochemical conversion catalyst may be coated on or dispersed with the electronically conductive component. In some embodiments, high electrical conductivity through the catalyst layer aids in the overall rate of hydrogen production.

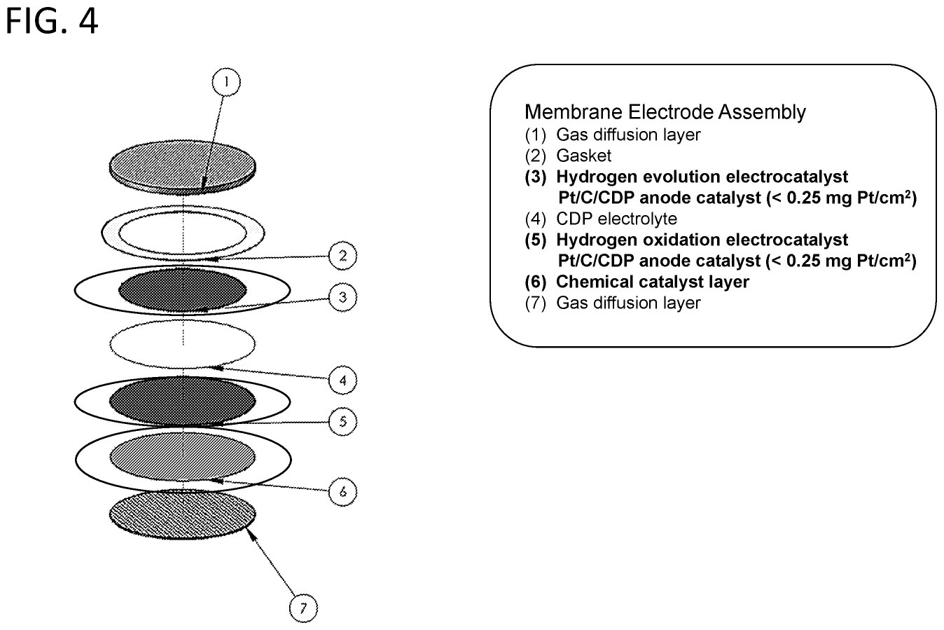

For non-ammonia fuels, the thermochemical conversion catalyst will catalyze chemical reactions other than ammonia decomposition, and so it can be referred to more generally as a catalyst layer (see layer 6 of FIG. 4). Some examples of chemical reactions, other than ammonia decomposition, include: steam reforming of methanol and dimethyl ether; dehydrogenation of formic acid, methylcyclohexane and perhydro-dibenzyl-toluene; and water-gas-shift of carbon monoxide. Even though carbon monoxide is not inherently a carrier of hydrogen, carbon monoxide can be used to produce hydrogen via the water-gas-shift reaction:

CO+H₂O→CO₂+H₂ (2)

This reaction is particularly important because carbon monoxide is often produced alongside hydrogen in the reforming reactions of carbon-based fuels, such as methanol, dimethyl ether, and formic acid. Therefore, the ability of the solid acid electrochemical cell to produce hydrogen directly from the carbon-based fuel, as well as the water-gas-shift reaction of any carbon monoxide produced in the steam reforming of such fuels, improves the overall efficiency of the hydrogen generation process.

The H₂ formed in the catalyst layer flows into the electrooxidation layer, while unused fuel and other conversion products exit the cell. The electrooxidation catalyst catalyzes the oxidation of the H₂ to generate hydrogen ions (Hf) and electrons. Examples of hydrogen oxidation catalysts include noble metals, such as Pt and palladium (Pd). However, other catalysts, such as non-noble metal catalysts, including Ni, and bimetallic catalysts can also be used. Conductive supports, such as particles of carbon black and/or proton conducting metal phosphates, may also be included in the electrooxidation layer, wherein the hydrogen oxidation catalyst may be coated on or dispersed in the support material. It should be noted that, as used herein, the term “adjacent” does not require adjacent layers to be in direct physical contact; although in some embodiments, the layers are in direct physical contact. Adjacent layers may be next to one another but separated by intervening layers of material that do not alter or impede the respective layers from carrying out their intended functions and that do not significantly impede the flow of reactants through the electrochemical cell. For example, a thin layer of material may be inserted between the layers to provide structural integrity and/or to simplify cell assembly.

The hydrogen ions generated in the electrooxidation layer are selectively passed through the solid-state proton conducting membrane, while the electrons travel to the hydrogen evolution layer via a connecting circuit (e.g., wire). Examples of solid-state proton conducting membrane materials include solid acids having a stable superprotonic phase at the intended operating temperature of the electrochemical cell, for example, in the temperature range from 180° C. to 300° C. Superprotonic phases are characterized by orientationally-disordered acidic oxyanion groups and high protonic conductivities, including conductivities of 1×10'S cm⁻¹ or greater. Metal phosphates and, in particular, cesium phosphates, such as cesium dihydrogen phosphate, are examples of solid acids that can have stable superprotonic phases. Descriptions of other proton conducting solid acids, including metal phosphates, can be found in Haile et al, Faraday discussions 134 (2007): 17-39 and in U.S. Pat. No. 8,202,663, the disclosures of which are incorporated herein for the purpose of providing additional specific examples of solid acids that can be used as solid-state electrolytes.

The proton conducting materials used in the proton conducting membranes can also be used as proton conducting support materials in the electrooxidation layer and the hydrogen evolution layer.

The hydrogen ions that flow through the proton conducting membrane and into the hydrogen evolution layer are catalytically reduced by the hydrogen evolution catalyst to form H₂, which then passes out of the electrochemical cell. Examples of hydrogen evolution catalysts include noble metals, such as Pt and palladium. However, other catalysts, such as non-noble metal catalysts, including Ni, and bimetallic catalysts can also be used. Conductive supports, such as particles of carbon black and/or proton conducting metal phosphates, may also be included in the hydrogen evolution layer, wherein the hydrogen evolution catalyst may be coated on or dispersed in the support material.

### EXAMPLES

### Example 1: Hydrogen Production from Ammonia

This example illustrates a hybrid thermal-electrochemical approach to the ammonia conversion reaction at an intermediate temperature of 250° C., with the aim of simultaneously addressing the NH₃ impurities in the hydrogen produced by high-temperature thermochemical decomposition and the low conversion efficiency of ambient temperature electrolysis. Cs-promoted Ru/CNT was employed as the thermochemical decomposition catalyst. A cell based on the proton conducting electrolyte, cesium dihydrogen phosphate (CDP), a solid acid compound that is non-reactive with NH₃ was employed as the electrochemical component. The electrocatalyst was Pt, which has high tolerance to fuel impurities at the operation temperature of 250° C. (for example, up to 20% CO), suggesting electrochemical functionality even in the presence of residual NH₃. By integrating the thermochemical decomposition with electrochemical removal of hydrogen from the reaction zone, thermodynamic limitations otherwise imposed by product accumulation were overcome.

The overall configuration of the ammonia decomposition cells is presented in FIG. 1. The internal thermal cracking catalyst layer (TCL) was placed adjacent to the hydrogen oxidation electrocatalyst layer (EL), in turn adjacent to the CDP electrolyte. The entire structure, which includes a hydrogen evolution electrocatalyst layer at the counter electrode, was placed between stainless steel mesh current collectors.

### Results and Discussion

Using three distinct cells to assess reproducibility, leakage through the electrolyte membrane was first checked for by measuring the open circuit voltage (OCV) with dilute H₂ supplied to the working electrode. The recorded voltages of 72, 73, and 73 mV are consistent with the value of 73 mV implied by the Nernst equation.

The agreement between the Nernst equation and measured values demonstrated not only the absence of gas leaks, but also the high ionic transference number of CDP. The electrochemical characteristics were then assessed under open circuit conditions by impedance spectroscopy. The measured ohmic losses of 0.24-0.26 Ωcm² were comparable to the expected value of 0.25 Ωcm² for the 50 μm thick electrolyte with conductivity of 2.0×10⁻²S/cm at 250° C.

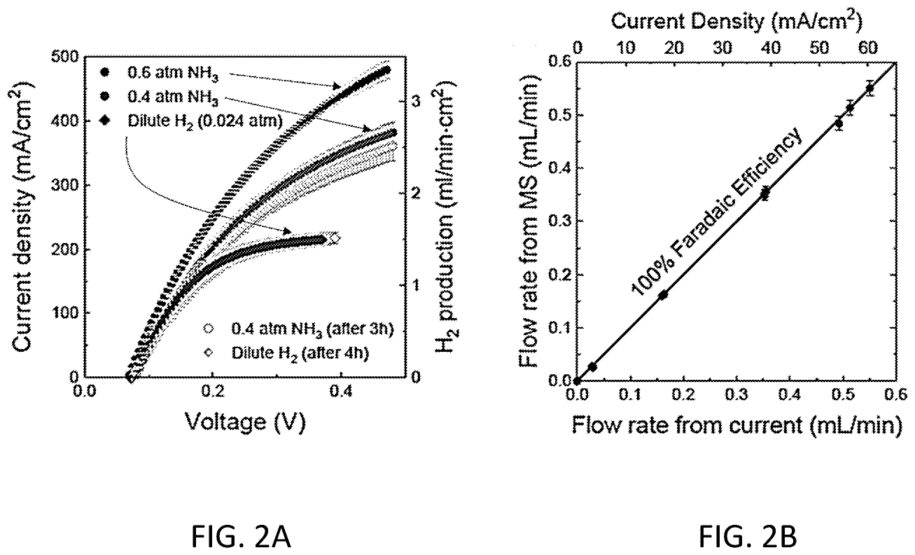

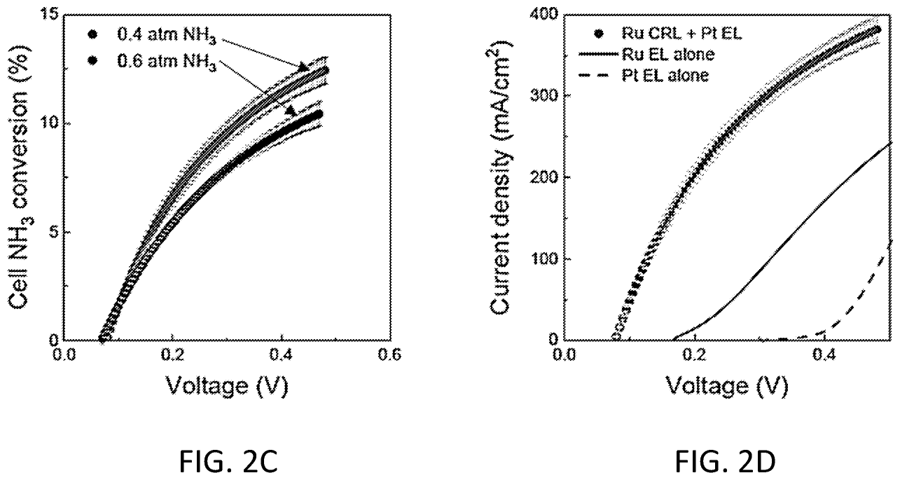

Polarization curves obtained under ammonia flow revealed excellent activity for ammonia decomposition, FIG. 2A, as well as excellent cell-to-cell reproducibility, Table 1. Good stability was indicated by the coincidence of the curves for the low NH₃ condition measured before and after exposure to high NH₃. Significantly, the Faradaic efficiency for hydrogen production was 100%, FIG. 2B, and the generated hydrogen was free of impurities. The data moreover immediately reveal that substantially higher current densities were obtained upon supplying humidified NH₃ rather than humidified H₂, implying that electrochemical splitting of H₂O, which is in any case thermodynamically unfavorable, did not contribute to the observed currents. Accordingly, FIG. 2C shows the implied ammonia to hydrogen conversion rates, computed from the ammonia supply rates in conjunction with the observation of 100% Faradaic efficiency. The possibility of reaction of NH₃ with H₂O during the ammonia oxidation reaction to form oxidized nitrogen (which would not impact the current efficiency for hydrogen production or hydrogen purity, but would nevertheless be detrimental) was eliminated by chemical analysis of the anode side exhaust gas.

TABLE 1
Summary of electrical characteristics of three independent
cells for ammonia to hydrogen electrochemical conversion.

| | | Current Density | | | Current Density | |
|---|---|---|---|---|---|---|
| | at 0.4 | (mA/cm²) at voltage | | at 0.6 | (mA/cm²) at voltage | |
| Cell | pNH₃ | indicated | | pNH₃ | indicated | |
| No. | OCV (V) | 0.15 V | 0.3 V | OCV (V) | 0.15 V | 0.3 V |
| 1 | 78 | 126 | 280 | 63 | 173 | 365 |
| 2 | 78 | 137 | 299 | 67 | 163 | 356 |
| 3 | 78 | 142 | 299 | 69 | 173 | 367 |
| Ave | 78 ± 1 | 135 ± 8 | 293 ± 11 | 68 ± 4 | 170 ± 6 | 363 ± 6 |

The voltages obtained under open circuit conditions were 78±1 and 68±4 mV (as averaged across the three cells), for the respective ammonia partial pressures of 0.4 and 0.6 atm. Inverting the Nernst relationship, these voltages imply hydrogen partial pressures at the working electrode of 0.019 and 0.033 atm, respectively. From this, respective chemical ammonia-to-hydrogen conversion rates of 3.4±0.1 and 3.5±0.7% were computed at the two ammonia concentrations.

Away from open circuit conditions, the current rose under both ammonia and dilute hydrogen with a relatively low overall cell resistance, indicating rather moderate and similar overpotentials. Because the hydrogen partial pressures were similar between the three conditions (pH₂=0.024, 0.019 and 0.033 atm, respectively, in dilute hydrogen, and at OCV in dilute and concentrated ammonia), the similarities in IV characteristics indicate that poisoning of the Pt electrocatalyst by unreacted NH₃ was negligible. This was further corroborated by the impedance results, which indicate similar electrochemical reaction resistance for supply of dilute H₂ and of NH₃ under OCV conditions, with electrochemical reaction resistances ranging from 0.16 to 0.19 Ωcm².

With increasing current and voltage, the IV curves deviated from linearity and from one another. In the case of dilute hydrogen, the IV curve plateaued relatively sharply at a current density corresponding to ˜90% of the limiting value, consistent with the supposition that depletion of hydrogen was responsible for the declining rate of increase in cell current density, and that H₂O electrolysis did not occur under these conditions. Under ammonia, the IV curves followed a much more gradual change in slope. Substantially higher current densities were achieved using 0.6 rather than 0.4 atm pNH₃. This behavior is consistent with electrochemical oxidation of ammonia being the source of the current. The resulting increase in current density, and hence hydrogen production rate, was, however, accompanied by a decrease in conversion efficiency, FIG. 2C. Conversion efficiency can be improved by increasing the catalyst architecture to facilitate removal of product N₂, or by increasing the thickness of the TCL to increase the residence time, so long as this occurs without increasing the mass diffusion resistance. The polarization characteristics obtained here indicate performance characteristics that are far superior to those reported for alkali electrolysis cells, in which large overpotentials (˜0.4 V beyond the open circuit condition) must be overcome before non-negligible current flows. (Modisha, P., et al., (2016). International Journal of Electrochemical Science 11, 6627-6635; and Vitse, F. et al., (2005). Journal of Power Sources 142, 18-26.)

In the absence of the thermal cracking catalyst layer, FIG. 2D, the 20% Pt-C/CDP electrocatalyst displayed a relatively high OCV ˜365 mV under pNH₃ of 0.4 atm, indicating negligible thermal ammonia decomposition (<1×10⁻⁵% conversion). The resulting currents under voltage bias were ˜1% of the values obtained from the cells incorporating explicit thermal cracking layers. From this it can be concluded that, in the cells with distinct cracking and electrochemical catalyst layers, the Pt served only to oxidize the hydrogen, at least up to 0.36 V, with the Ru-based catalyst accounting for almost the entirety of the NH₃ dissociation. On the other hand, in the absence of the Pt based electrocatalyst, the cell with only the Ru/CNT+CDP dual-function catalyst layer displayed surprisingly poor IV curves, FIG. 2D. When 0.4 atm pNH₃ was supplied, the open circuit voltage was 170 mV (equivalent to 0.05% conversion), in contrast to the 78 mV recorded from the bilayer electrode system. The omission of the CsNO₃ promotor in this catalyst was likely the cause, as Ru was active for hydrogen electro-oxidation under low current conditions. The result indicates that CDP is ineffective as a promotor, presumably because the phosphate anion is retained in the material at the temperatures of interest, preventing conversion to CsOH.

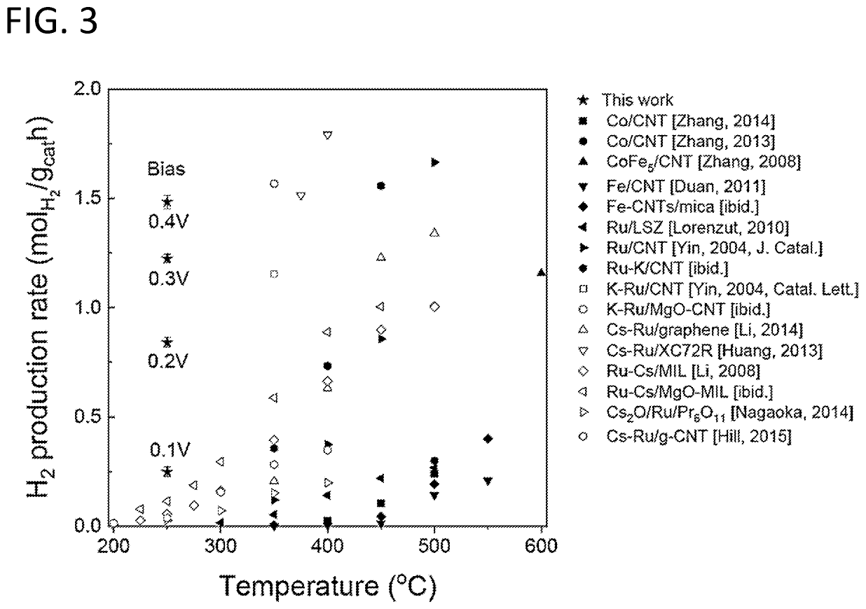

It is shown here that by integrating electrochemical product removal with thermal decomposition of ammonia, it is possible to generate hydrogen at a substantially higher rate than by thermal decomposition alone. To put the present results into context, the hydrogen production rates achieved here are compared, on a catalyst-mass normalized basis, to those from conventional thermal-cracking experiments reported in the literature, FIG. 3. (Hill, A. K. et al., (2015). Applied Catalysis B-Environmental 172, 129-135; Li, J. P. et al., (2018). Nano Research 11, 4774-4785; Zhang, H. et al., (2014). International Journal of Hydrogen Energy 39, 17573-17582; Nagaoka, K. et al., (2014). International Journal of Hydrogen Energy 39, 20731-20735; Li, G. et al., (2014). Journal of Materials Chemistry A 2, 9185-9192; Zhang, H. et al., (2013). Applied Catalysis a-General 464, 156-164; Huang, D. C. et al., (2013). International Journal of Hydrogen Energy 38, 3233-3240; Duan, X. Z. et al., (2011). Applied Catalysis B-Environmental 101, 189-196; Lorenzut, B. et al., (2010). ChemCatcChem 2, 1096-1106; Zhang, J. et al., (2008). Individual Fe—Co alloy nanoparticles on carbon nanotubes: Structural and catalytic properties. Nano Letters 8, 2738-2743; Yin, S. F. et al., (2004). Journal of Catalysis 224, 384-396; and Yin, S. F. et al., (2004). Catalysis Letters 96, 113-116.) The hydrogen production rates were computed from the ammonia conversion and gas flow rates given in those publications. For this example, the catalyst in both the TCL and complete electrochemical cell were included in the normalization. From this representation, it is evident that application of moderate bias (0.4 V) results in a catalyst-mass normalized hydrogen production rate that matches the results obtained from thermal decomposition at a much higher temperature of 350 to 500° C. Furthermore, the evolved hydrogen is free of residual ammonia, and the configuration is amenable to electrochemical compression of hydrogen, or to operation of a direct ammonia fuel cell without risk of generating NOR.

### Experimental Procedures

### CDP Stability Analysis

CDP powder was exposed to flowing humidified NH₃ (pNH₃=0.4 atm, pH₂O=0.38 atm, balance N₂) at a total gas flow rate of 50 sccm at 250° C. for 24 h. During the heating to the exposure condition, the gas supply was started after the sample reached a temperature of 150° C., and similarly on cooling the gas supply was stopped at this temperature. Diffraction patterns collected before and after NH₃ exposure were identical.

### Synthesis

The catalyst for the TCL was prepared following the polyol method in which ethylene glycol (Fisher Chemical, >95% purity) serves to reduce a metal salt precursor (RuCl₃·4.5H₂O, Alfa Aesar, 99.9% metals basis). (Kurihara, L. K. et al., Nanostructured Materials 5, 607-613.) The Ru loading on the multi-walled CNTs (NanoLab, >95% purity) was fixed at 60 wt. %, at which the ˜30 nm diameter CNTs were fully coated with Ru nanoparticles. Cesium promotion was achieved by dispersing the Ru/CNT into a 50 mM aqueous solution of CsNO₃ (Alfa Aesar, 99.9%) with 1:1 molar ratio of Ru:Cs. The water was gently evaporated to induce precipitation of the nitrate. To promote uniformity, the powder was dispersed in ethanol and the solvent evaporation was repeated. Cells were fabricated using 53.4 mg of the Cs-promoted Ru/CNT material. The Ru crystallite size was 7 nm as determined by transmission electron microscopy imaging and X-ray powder diffraction. On the basis of thermogravimetric analysis, it can be concluded that crystalline CsNO₃ obtained from the synthesis was decomposed to CsOH under H₂, in a reaction that was apparently catalyzed by metallic Ru. As has been suggested in the literature, it is likely the decomposition process places CsOH in near proximity to the Ru. (Larichev, Y. V. et al., (2007). Journal of Physical Chemistry C 111, 9427-9436; and Aika, K.-i. (2017). Catalysis Today 286, 14-20.)

### Cell Preparation

Three cells, 0.75″ in diameter, were fabricated and evaluated for ammonia decomposition. The EL was comprised of Pt/carbon (20 wt. % Pt on carbon black, HiSPEC® 3000, Alfa Aesar) and CDP (SAFCell) in a 1:6 mass ratio, as described in previous works (in which this component served as a hydrogen oxidation electrode). (Papandrew, A. B. et al., (2011). Chemistry of Materials 23, 1659-1667; and Lim, D. K. et al., (2018) Electrochimica Acta 288, 12-19.) For both TCL and EL components, 25 mg was used, resulting in respective Ru and Pt loadings of 10.3-11.1 and 0.5 mg/cm² over the active cell area of 1.34-1.45 cm². For ease of fabrication, a layer of carbon fiber paper (Toray, TGP-H-030) was placed between the two catalytic layers. The CDP electrolyte layer was 50 mg in mass and fully densified to yield a thickness of 50 μm. The hydrogen evolution (counter) electrode had the same formulation as the electrocatalyst in the working electrode and resulted in an additional 0.5 mgₚₜ/cm² in the complete cell. For the purpose of assessing the role of individual components, two analogous additional cells were fabricated, the first in which the Ru-based TCL was omitted, and the second in which the Pt-based EL was omitted. In the latter case, 60 wt. % Ru/CNT, prepared as described above, was combined with CDP in a 1:6 mass ratio to serve as a direct ammonia oxidation electrocatalyst. Because of reactivity between CDP and most Cs salts, no additional promotor was applied.

### Electrochemical Measurements

Electrochemical measurements (BioLogic, SP-300) were performed at 250° C. at a scan rate of 10 mV/s. Gas streams supplied to the anode and cathode were humidified (with steam partial pressure, pH₂O, of 0.38 atm) to prevent dehydration of the CDP electrolyte. Humidified hydrogen (pH₂=0.62 atm) was supplied to the counter electrode, and either humidified ammonia at one of two concentrations (pNH_{3=0.4} or 0.6 atm) or dilute humidified hydrogen (pH₂=0.024 atm), balanced by a mixture of Ar and Nz, was supplied to the working electrode. The total gas flow rates at both electrodes were 50 sccm (standard cubic centimeters per minute) for all conditions. These flow rates imply limiting current densities for the 0.4 atm and 0.6 atm NH₃ fed cells of 3.0-3.2 A/cm² and 4.5-4.8 A/cm², respectively, based on the cell active areas and the hydrogen content of the supplied ammonia. Under supply of dilute Hz, the limiting currents were 247-267 mA/cm². Faradaic efficiency measurements were performed under similar conditions, but with humidified N₂ (pH₂O=0.38 atm) supplied to the counter electrode so as to ensure detection of only electrochemically evolved hydrogen and avoid drift of a high baseline in the mass spectrometer (Thermostar Pfeiffer GSD 301 T2) used for evolved gas chemical analysis.

### Example 2: Hydrogen Production from Other Fuels

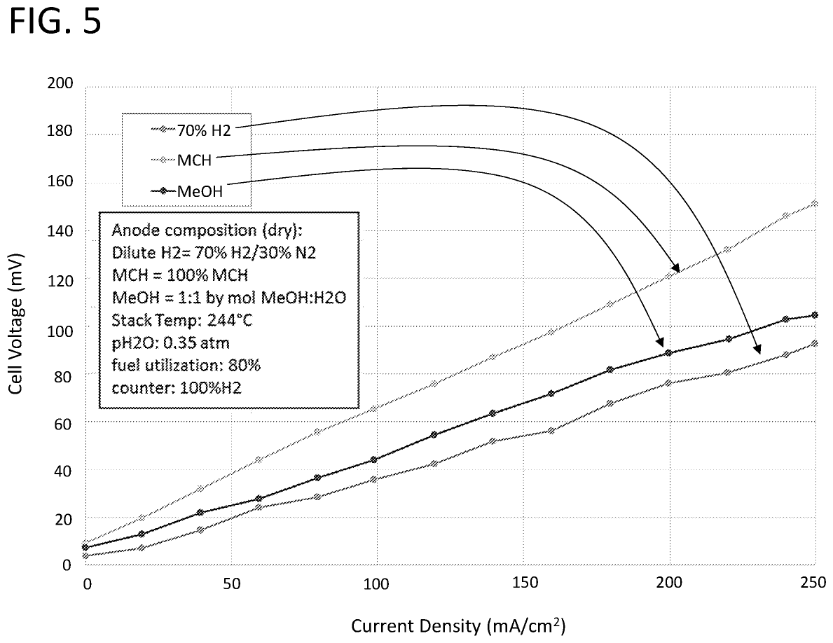

Polarization curves were obtained for a 12-cell solid acid hydrogen stack running on H₂, methylcyclohexane (MCH), and methanol (MeOH) (FIG. 5). Active surface areas of the cells were approximately 50 cm². The hydrogen oxidation and hydrogen evolution layers (layers 5 and 3, respectively in FIG. 4), were composed of 20 wt % platinum on carbon mixed with CsH₂PO₄ solid acid electrolyte. The electrolyte layers (layer 4 of FIG. 4) were composed of CsH₂PO₄ with a thickness of approximately 50 microns. The chemical catalyst layers (layer 6 of FIG. 4) were composed of 4 wt % platinum on ceria mixed with graphite. Average stack temperature was T=244° C.; fuel gases were hydrated with water with ˜0.35 atm pH₂O on the anode and cathode. Flow rates of the fuels were varied, so that for each data point, 80% of the theoretically available hydrogen in the fuel stream was consumed by the electrochemical reactions (i.e., fuel utilization was 80%). For the MCH and MeOH polarization curves, this 80% fuel utilization was calculated assuming full conversion of the MCH or MeOH to hydrogen and toluene or carbon dioxide, respectively. Pure hydrogen, diluted by 0.35 atm pH₂O, was fed to the hydrogen evolution electrodes to make this electrode act as a pseudo hydrogen reference electrode, so as to better resolve the performance of the stack on the various fuels.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” can mean only one or can mean “one or more.” Both embodiments are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An electrochemical cell for the production of hydrogen from a fuel comprising:
a catalyst layer comprising a thermochemical conversion catalyst;
an electrooxidation layer comprising a hydrogen oxidation catalyst adjacent to the catalyst layer;
a proton conducting membrane comprising a solid acid electrolyte adjacent to the electrooxidation layer;
a hydrogen evolution layer comprising a hydrogen evolution catalyst that is separated from the electrooxidation layer by the proton conducting membrane; and
a circuit that provides a path for electrons generated in the electrooxidation layer to travel to the hydrogen evolution layer.

2. The electrochemical cell of claim 1, wherein the catalyst layer further comprises an electronically conductive component.

3. The electrochemical cell of claim 2, wherein the thermochemical conversion catalyst is a catalyst for the thermal decomposition of ammonia.

4. The electrochemical cell of claim 3, wherein the thermochemical conversion catalyst comprises ruthenium and carbon.

5. The electrochemical cell of claim 2, wherein the thermochemical conversion catalyst is a catalyst for the chemical conversion of methanol and water into carbon dioxide and hydrogen.

6. The electrochemical cell of claim 5, wherein the thermochemical conversion catalyst comprises copper, zinc, and carbon.

7. The electrochemical cell of claim 5, wherein the thermochemical conversion catalyst comprises platinum and carbon.

8. The electrochemical cell of claim 2, wherein the thermochemical conversion catalyst is a catalyst for the chemical conversion of dimethyl ether and water into carbon dioxide and hydrogen.

9. The electrochemical cell of claim 2, wherein the thermochemical conversion catalyst is a catalyst for the chemical conversion of carbon monoxide and water into carbon dioxide and hydrogen.

10. The electrochemical cell of claim 2, wherein the thermochemical conversion catalyst is a catalyst for the chemical conversion of formic acid into carbon dioxide and hydrogen.

11. The electrochemical cell of claim 2, wherein the thermochemical conversion catalyst is a catalyst for the chemical conversion of methylcyclohexane into toluene and hydrogen.

12. The electrochemical cell of claim 11, wherein the thermochemical conversion catalyst comprises platinum and carbon.

13. The electrochemical cell of claim 2, wherein the thermochemical conversion catalyst is a catalyst for the chemical conversion of perhydro-dibenzyl-toluene into dibenzyl-toluene and hydrogen.

14. The electrochemical cell of claim 2, wherein the thermochemical conversion catalyst is a catalyst for the chemical conversion of propanol-2 into acetone and hydrogen.

15. The electrochemical cell of claim 2, wherein the thermochemical conversion catalyst is a catalyst for the chemical conversion of perhydro-N-ethylcarbazole into N-ethylcarbazole and hydrogen.

16. The electrochemical cell of claim 2, wherein the thermochemical conversion catalyst comprises ruthenium, platinum, palladium, iridium, rhodium, rhenium, nickel, cobalt, chrome, tin, indium, titanium, tantalum, copper, zinc, or any combination of two or more thereof.

17. The electrochemical cell of claim 1, wherein the catalyst layer further comprises a support for the thermochemical conversion catalyst, a promoter for the thermochemical conversion catalyst, or both.

18. The electrochemical cell of claim 1, wherein the solid acid electrolyte is a proton conducting metal phosphate having a stable superprotonic phase at an electrochemical cell operating temperature.

19. The electrochemical cell of claim 18, wherein the metal phosphate is a cesium phosphate.

20. The electrochemical cell of claim 19, wherein the cesium phosphate comprises cesium dihydrogen phosphate.
